(19) United States
(12) Patent Application Publication
(10) Pub. No.: US 2010/0287317 A1
(43) Pub. Date: Nov. 11, 2010

(54) Source Driver System Having an Integrated Data Bus for Displays

(76) Inventors: Wan-Hsiang Shen, Taipei (TW); Jyh-Ting Lai, Taipei (TW); Wei-Kang Hsu, Taipei (TW); Wei-Bo Su, Taipei (TW); Shao-Jung Wang, Taipei (TW); Jen-Hung Tung, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/542,019

(22) Filed: Aug. 17, 2009

(30) Foreign Application Priority Data
May 5, 2009 (TW) 098115129

(51) Int. Cl. G06F 13/00

(52) U.S. Cl. 710/107

(57) ABSTRACT

A source driver system includes a scan driver and a data driver. The data driver has a signal controller, a data bus, a connector and a plurality of data driver units. The signal controller is connected with the connector with via the data bus to form a first connection relationship such that the data bus is capable of transmitting control signals from the signal controller to the connector. The connector connects with the data driver units via the data bus to form a second connection relationship such that the data bus is capable of transmitting the control signals from the connector to the corresponding data driver units. In a preferred embodiment, the data bus is further arranged to form a third connection relationship among the data driver units such that the data bus is capable of communicating a serial connection signal among the data driver units.

### BACKGROUND OF THE INVENTION

1. Field of the Invention

The present invention relates to a source driver system having an integrated data bus for displays. More particularly, the present invention relates to the source driver system utilizing the data bus to provide a plurality of integrated connections in the system.

2. Description of the Related Art

Taiwanese Patent Pub. No. I286299, entitled “SOURCE DRIVER FOR DISPLAY,” discloses a conventional display having a source driver system. Referring to FIG. 1, a schematic view of the source driver system of the display according to TWN Patent Pub. No. I286299 is disclosed. With continued reference to FIG. 1, the source driver system includes a scan driver 11 and a data driver 12 so as to control a LCD display (not shown in FIG. 1) to display images.

Still referring to FIG. 1, the scan driver 11 includes, for example, 256 scan lines (identified as G1, G2, . . . , G256), and is operated to serially scan the scan lines G1, G2, . . . G256 so as to control a plurality of pixels of the LCD display. Each of the pixels is controlled and generated from a corresponding thin film transistor (not shown), which may be abbreviated as “TFT”. Furthermore, the scan lines G1, G2, . . . , G256 electrically connect with gates of the corresponding thin film transistors for controlling on/off operations of the corresponding gates.

Still referring to FIG. 1, the data driver 12 can send associated drive signals to the thin film transistor to control primary colors (for example: R, G, B) and brightness of the pixel, as best shown in the upper portion of FIG. 1, so that the LCD display can be operated to generate a series of predetermined images by the control of the scan driver 11 and the data driver 12.

With continued reference to FIG. 1, the data driver 12 includes a signal controller, a plurality of connectors and a plurality of data driver units. The signal controller is adapted to receive signals transmitted from a computer or a signal source, and to process them by means of suitable manners. Consequently, the signal controller generates a control signal to send to the data driver units via the corresponding connectors. Each of the data driver units is operated to generate drive signals to the corresponding thin film transistor in response to the control signal, as best shown in the upper portion of FIG. 1.

Still referring to FIG. 1, however, the signal controller of the data driver provided in the conventional source driver system requires the number of the data driver units consistent with those of connectors. When the number of the data driver units increase, the number of the connectors must increase. Inevitably, the number of system components must be increased and the design of the entire system must also be sophisticated. In consideration of reducing the number of system components, there is a need of improving the connection of the data bus to solve the above problem.

In addition to this, there is a need of providing serially connected relations among the data driver units in the conventional source driver system to communicate a serial connection signal among the data driver units. Hence, there is a need of providing an additional data bus for communicating the serial connection signal among the data driver units due to the fact that any original data bus provided in the conventional source driver system cannot provide any common transmission for communicating the serial connection signals. Inevitably, the number of components must be further increased and the design of the entire system must be further sophisticated.

The source driver system has been described in many Taiwanese patent application publications and issued patents, for example, including TWN patent appl. publication No. 200909914, TWN patent application Pub. No. 200907893, TWN patent application Pub. No. 200907909, TWN patent application Pub. No. 200849204, TWN patent application Pub. No. 200844946, TWN patent application Pub. No. 200832315, TWN patent application Pub. No. 200813930, TWN patent application Pub. No. 200813973, TWN patent application Pub. No. 200744039, TWN patent application Pub. No. 200727707, TWN patent application Pub. No. 200721083, TWN patent application Pub. No. 200713188, TWN patent application Pub. No. 200713189, and TWN patent application Pub. No. 200615893; and TWN patent issued Pub. No. I286299 and TWN patent issued Pub. No. I270038. Each of the above-mentioned Taiwanese patent application publications and issued patents is incorporated herein by reference for purposes including, but not limited to, indicating the background of the present invention and illustrating the state of the art.

Further, the source driver system has also been described in many U.S. patent application publications and issued patents, for example, including US20070290979, US20070063134, US20030052854, US2006279260, US2003052854, US20080030453, US20080001944, US20080001898, US20070229440, US20070182690, US20070057327, US20060152466, US20060022930, US20050270263, US20050168432, US20050162374, US20030231153, US20020175662 and US20010007135; and, U.S. Pat. No. 7,471,289, U.S. Pat. No. 7,436,381, U.S. Pat. No. 7,432,904, U.S. Pat. No. 7,425,941, U.S. Pat. No. 7,327,299, U.S. Pat. No. 7,327,297, U.S. Pat. No. 7,304,621, U.S. Pat. No. 7,292,217, U.S. Pat. No. 7,259,742, U.S. Pat. No. 7,187,421, U.S. Pat. No. 7,180,323, U.S. Pat. No. 7,050,033, U.S. Pat. No. 6,970,153, U.S. Pat. No. 6,954,192, U.S. Pat. No. 6,950,045, U.S. Pat. No. 6,831,620, U.S. Pat. No. 6,747,626, U.S. Pat. No. 6,727,880, U.S. Pat. No. 6,333,730, U.S. Pat. No. 6,075,524, U.S. Pat. No. 5,744,986, U.S. Pat. No. 7,342,567, U.S. Pat. No. 7,199,575, U.S. Pat. No. 7,180,323, U.S. Pat. No. 6,963,323, U.S. Pat. No. 6,718,478, U.S. Pat. No. 6,384,805, U.S. Pat. No. 6,335,721, U.S. Pat. No. 6,326,913 and U.S. Pat. No. 6,008,801. Each of the above-mentioned U.S. patent application publications and issued patents is incorporated herein by reference for purposes including, but not limited to, indicating the background of the present invention and illustrating the state of the art.

Yet further, the source driver system has also been described in many foreign patent application publications and issued patents, for example, including JP2008116936, JP2007299013, JP2007206454, JP2007156503, JP2004296741, JP2000098331, JP7318892 and JP54107698; KR20080012419, KR20070009295, KR20040078446 and KR20030058520; CN101334552, CN101136184, CN101089937, CN1784708, CN1536549 and CN1655018. Each of the above-mentioned Intl. patent application publications and issued patents is incorporated herein by reference for purposes including, but not limited to, indicating the background of the present invention and illustrating the state of the art.

As is described in greater detail below, the present invention intends to provide a source driver system having an integrated data bus for displays. The data bus is provided to form a plurality of integrated connections so as to reduce the amount of connectors arranged in the system in such a way as to mitigate and overcome the above problem.

### SUMMARY OF THE INVENTION

The primary objective of this invention is to provide a source driver system having an integrated data bus for displays, wherein the data bus is provided to form integrated connections so as to reduce the amount of connectors arranged in the system. Accordingly, the amount of connectors arranged in the source driver system can be reduced.

The source driver system in accordance with an aspect of the present invention includes a scan driver and a data driver. The data driver has a signal controller, a data bus, a connector and a plurality of data driver units. The data bus is provided to form integrated connections among the data driver units. The data bus connects the connector with the signal controller, and the connector further connects with the data driver units via the data bus. In operation, the data bus is capable of sending control signals from the signal controller to the corresponding data driver units via the data bus and the connector.

The source driver system in accordance with a separate aspect of the present invention includes a scan driver and a data driver. The data driver has a signal controller, a data bus, a connector and a plurality of data driver units. The signal controller is connected with the connector with via the data bus to form a first connection relationship such that the data bus is capable of transmitting control signals from the signal controller to the connector. The connector connects with the data driver units via the data bus to form a second connection relationship such that the data bus is capable of transmitting the control signals from the connector to the corresponding data driver units.

In a further separate aspect of the present invention, the data bus is arranged to form a third connection relationship among the data driver units such that the data bus is capable of communicating a serial connection signal among the data driver units.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a source driver system for displays in accordance with TWN Patent Pub. No. I286299.

FIG. 2 is a schematic block diagram of a data driver provided in a source driver system for displays.

FIG. 3 is a schematic block diagram of a data driver, provided in a source driver system, having an integrated data bus for displays in accordance with the preferred embodiment of the present invention.

### DETAILED DESCRIPTION OF THE INVENTION

It is noted that a source driver system having an integrated data bus for displays in accordance with the preferred embodiment of the present invention can be applicable to a wide variety of different source driver systems of liquid crystal displays (may be abbreviated as “LCDs”) or the like; and can be implemented on a suitable semiconductor chip or the like which is not limitative of the present invention.

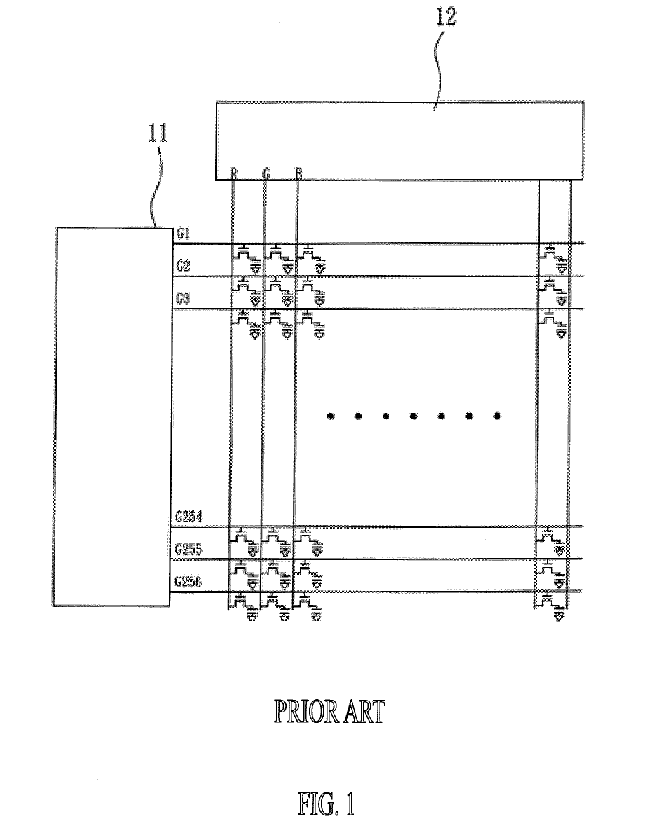

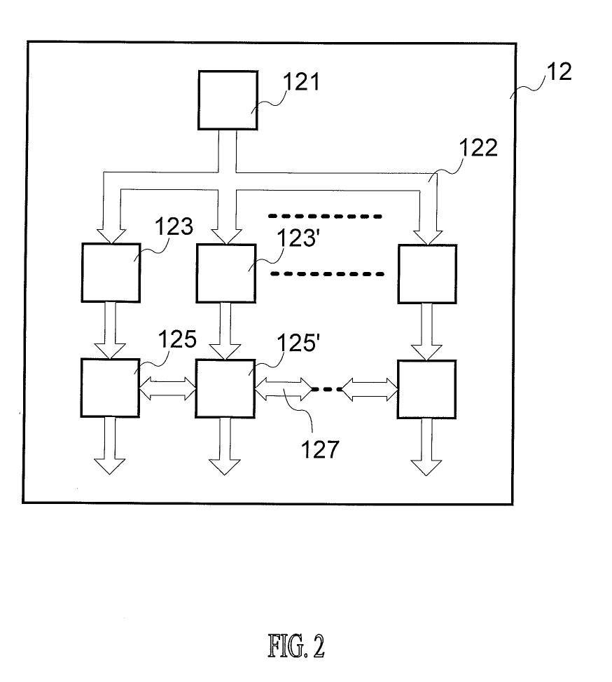

The source driver system in accordance with the preferred embodiment of the present invention includes a scan driver and a data driver similar to those conventional drivers shown in FIG. 1, which are indicated for simplification of description and not by way of limitation. Throughout the specification, similar or identical elements will be given consistent identifying numerals throughout FIGS. 1 and 2.

FIG. 2 illustrates a data driver which may be provided in a source driver system for displays. Referring to FIG. 2, the data driver 12 includes a signal controller 121, at least one data bus 122, a plurality of connectors 123, 123′ and a plurality of data driver units 125, 125′. The signal controller 121 is used to receive signals from a computer device or signal source (not shown in FIG. 2). After receiving the signal, the signal controller 121 is operated to convert an analog signal to a digital signal which is further processed by signal ratio amplification or reduction and timing control. Subsequently, control signals are output to the corresponding data driver units 125, 125′ via the corresponding connectors 123, 123′, and a serial connection signal 127 is transmitted among the data driver units 125, 125′. The data driver units 125, 125′ are capable of sending drive signals to a number of the corresponding thin film transistors according to the control signals, as best shown in the middle portion of FIG. 1.

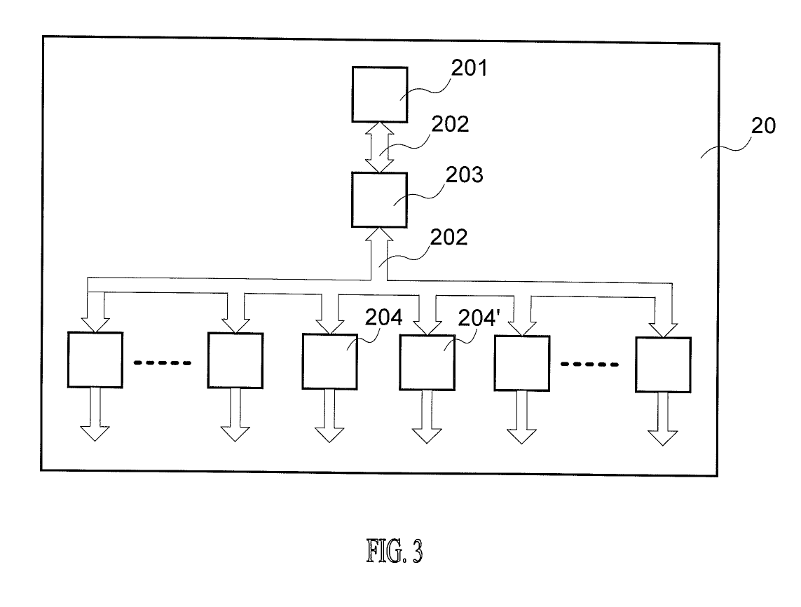

FIG. 3 illustrates a data driver provided in a source driver system for displays in accordance with the preferred embodiment of the present invention. Referring to FIG. 3, in the preferred embodiment, the data driver 20 includes a signal controller 201, at least one data bus 202 (or a plurality of data bus), at least one connector 203 and a plurality of data driver units 204, 204′. The data bus 202 of the preferred embodiment is arranged to provide a plurality of integrated connections among the data driver units 204, 204′.

Still referring to FIG. 3, the signal controller 201 is used to receive signals from a computer device or signal source (not shown in FIG. 3). After receiving the signal, the signal controller 201 is operated to convert an analog signal to a digital signal which is further processed by signal ratio amplification or reduction and timing control.

With continued reference to FIG. 3, the signal controller 201 is connected with the connector 203 with via the data bus 202 to form a first connection relationship. Accordingly, the data bus 202 is arranged to transmit the control signal of the signal controller 201 such that the data bus 202 is capable of transmitting control signals from the signal controller 201 to the connector 203.

Still referring to FIG. 3, the connector 203 further connects with the data driver units 204, 204′ via the data bus 202 to form a second connection relationship. Accordingly, the data bus 202 is arranged to transmit the control signals from the connector 202 to the corresponding data driver units 204, 204′.

It is apparent from FIG. 3 that the data bus 202 is arranged to provide a first connection between the signal controller 201 and the connector 203, and the data bus 202 is further arranged to provide a second integrated connection between the connector 203 and the data driver units 204, 204′. Advantageously, the integrated connection of the data bus 202 can be successful in reducing the amount of the connectors 203 arranged in the source driver system.

With continued reference to FIG. 3, the data driver units 204, 204′ are capable of transmitting drive signals to a number of the corresponding thin film transistors, as best shown in the middle portion of FIG. 1, according to the control signals so that the primary colors and brightness of the pixel of the thin film transistors are controlled.

Still referring to FIG. 3, the data bus 202 is further arranged to provide a third connection relationship between the data driver units 204, 204′ such that the data bus 202 is capable of communicating a serial connection signal among the data driver units 204, 204′. Advantageously, such a connection of the data bus 202 between the data driver units 204, 204′ can be successful in simplifying the entire structure of the source driver system of the present invention.

Referring again to FIG. 3, in an alternative, the data driver 20 may further include another set of a signal controller, a data bus, a connector and a plurality of data driver units (not shown) in addition to the combination of the signal controller 201, the data bus 202, the connector 203 and the data driver units 204, 204′. The data bus of this preferred embodiment is arranged to provide a plurality of integrated connections among the data driver units. The constructions of the signal controller, the data bus, the connector and the data driver units in accordance with this preferred embodiment have similar configurations, same connections and same functions as those of the previous discussion, and detailed descriptions may be omitted.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A source driver system for displays, comprising:
a scan driver; and
a data driver having a signal controller, a data bus, a connector and a plurality of data driver units, the data bus being provided to form a plurality of integrated connections among the data driver units;
wherein the data bus connects the connector with the signal controller, and the connector further connects with the data driver units via the data bus such that the data bus is capable of sending control signals from the signal controller to the corresponding data driver units via the data bus and the connector.

2. The source driver system as defined in claim 1, wherein the data bus is arranged to form connections among the data driver units such that the data bus is capable of communicating a serial connection signal among the data driver units.

3. The source driver system as defined in claim 1, wherein the data driver further includes another set of a signal controller, a data bus, a connector and a plurality of data driver units; and the data bus is arranged to provide a plurality of integrated connections among the data driver units.

4. A source driver system for displays, comprising:
a scan driver; and
a data driver having a signal controller, a data bus, a connector and a plurality of data driver units;
wherein the signal controller is connected with the connector with via the data bus to form a first connection relationship such that the data bus is capable of transmitting control signals from the signal controller to the connector; and
wherein the connector connects with the data driver units via the data bus to form a second connection relationship such that the data bus is capable of transmitting the control signals from the connector to the corresponding data driver units.

5. The source driver system as defined in claim 4, wherein the data bus is arranged to form a third connection relationship among the data driver units such that the data bus is capable of communicating a serial connection signal among the data driver units.

6. The source driver system as defined in claim 4, wherein the data driver further includes another set of a signal controller, a data bus, a connector and a plurality of data driver units; and the data bus is arranged to provide a plurality of integrated connections among the data driver units.

7. A source driver system for displays, comprising:
a data driver having a signal controller, at least one data bus, at least one connector and a plurality of data driver units;
wherein the signal controller is connected with the connector with via the data bus to form a first connection relationship such that the data bus is capable of transmitting control signals from the signal controller to the connector; and
wherein the connector connects with the data driver units via the data bus to form a second connection relationship such that the data bus is capable of transmitting the control signals from the connector to the corresponding data driver units.

8. The source driver system as defined in claim 7, wherein the data bus is arranged to form a third connection relationship among the data driver units such that the data bus is capable of communicating a serial connection signal among the data driver units.

9. The source driver system as defined in claim 7, wherein the data driver further includes another set of a signal controller, a data bus, a connector and a plurality of data driver units; and the data bus is arranged to provide a plurality of integrated connections among the data driver units.
